(19) United States
(12) Patent Application Publication
(10) Pub. No.: US 2006/0119255 A1
(43) Pub. Date: Jun. 8, 2006

(54) Organic el device

(75) Inventor: Hiroshi Kimura, Nagano (JP)

Correspondence Address: ROSSI, KIMMS & McDOWELL LLP., P.O. BOX 826, ASHBURN, VA, 20146-0826, US

(73) Assignee: Fuji Electric Holdings Co., Ltd., Kawasaki-ku (JP)

(21) Appl. No.: 11/268,715

(22) Filed: Nov. 7, 2005

(30) Foreign Application Priority Data
Nov. 5, 2004 (JP) 2004-322738

(51) Int. Cl. H05B 33/24; H05B 33/22

(52) U.S. Cl. 313/504; 313/503; 428/690

(57) ABSTRACT

An organic EL device is disclosed that has a buffer layer that prevents degradation of a reflection electrode and an electron injection layer due to chemical reaction between the material of the reflection electrode and the material of the electron injection layer when the two materials are in contact with each other. The buffer layer also prevents movement of the material of the reflection electrode into an organic EL layer. The buffer layer further allows reduction of a driving voltage of the organic EL device. An organic EL device of the invention includes a transparent electrode, an organic EL layer including at least an organic light emitting layer and an electron injection layer, a buffer layer, and a reflection electrode laminated on a substrate in this order. The electron injection layer is in contact with the buffer layer and doped with an alkali metal or an alkaline earth metal. The buffer layer is formed from a conductive material that does not form an alloy with the material of the reflection electrode.

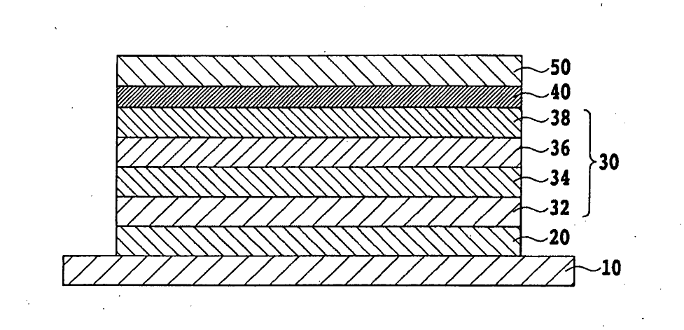

### CROSS REFERENCE TO RELATED APPLICATIONS

This application is based on, and claims priority to, Japanese Application No. 2004-322738, filed on Nov. 5, 2004, the contents of which are incorporated herein by reference.

### BACKGROUND OF THE INVENTION

A. Field of the Invention

The present invention relates to an organic EL device, in particular, to an organic EL device exhibiting good light emitting performance and low driving voltage, which are achieved by preventing degradation of a reflection electrode and an electron injection layer due to chemical reaction between a material of the reflection electrode and a material of the electron injection layer when the two materials directly contact each other, and by inhibiting the movement of the material of reflection electrode into an organic EL layer.

B. Description of the Related Art

A known example of light emitting devices that can be applied to display devices is an organic electroluminescence device (hereinafter referred to as “an organic EL device”) having a lamination structure of thin films of organic compounds. Since the publication on an organic EL device having a double-layered structure and exhibiting high efficiency light emission by C. W. Tang et al. of Eastman Kodak Company in 1987, various types of organic EL devices have been developed, and practical application has begun in some of the devices.

Currently, organic EL devices often have a multilayered structure comprising transparent electrode/hole injection layer/hole transport layer/organic light emitting layer/electron injection layer/reflection electrode, for example. Among these layers, a reflection electrode needs a glossy surface with high reflectivity and reliability as a wiring material. An electron injection layer needs a structure suited for electron injection to the organic light emitting layer. To meet these requirements, the Kodak group, for example, has disclosed that the low voltage driving can be achieved by inserting an alkali metal fluoride (such as LiF) of 5 to 10 Å between a reflection electrode of high reflectivity aluminum and an organic EL layer.

Kido et al. proposed to enhance the electron injection efficiency employing a reflection electrode of aluminum and an electron injection layer of an aluminum complex doped with an alkali metal such as lithium. T. Matsumoto et al. reported that an organic EL device employing such layers attains sufficiently low voltage (“A low voltage-driven organic EL device using a cathode buffer layer”, O Plus E, Vol. 22, No. 11, p. 1416-1421, 2000).

However, in the above-described structure that employs a reflection electrode of a metal such as aluminum with high reflectivity and conductivity and an electron injection layer of aluminum complex doped with an alkali metal, because of high reactivity of the electrode material itself (in particular, in the deposition process or during heating by a driving operation), the material forming the reflection electrode degrades suffers from oxidation by the material forming the electron injection layer, and at the same time, the material forming the electron injection layer degrades and suffers from reduction by the material forming the reflection electrode.

In addition, there is the possibility of degradation of the original performance of an organic EL layer due to the movement of a component of the material composing the reflection electrode into the organic EL layer. These effects have raised the problem of significant degradation of light emitting performance of the organic EL device.

In view of the above problems, an organic EL device is desired that has a buffer layer that prevents degradation of the reflection electrode and the electron injection layer due to chemical reaction between a highly reactive material of the reflection electrode and the material of the electron injection-layer that contains a doped alkali metal or alkaline earth metal when these two materials are directly in contact with each other. The buffer layer should inhibit the movement of the material of the reflection electrode into the organic EL layer. It is also desirable to provide an organic EL device that has a buffer layer that allows the driving voltage of the organic EL device to lower from that of the conventional devices. The present invention is directed to overcoming or at least reducing the effects of one or more of the problems set forth above.

### SUMMARY OF THE INVENTION

To solve the above problems, the present invention provides an organic EL device as described in the following.

An organic EL device of the invention comprises a substrate, a transparent electrode formed on the substrate, an organic EL layer formed on the transparent electrode, the organic EL layer including at least an organic light emitting layer and an electron injection layer, a buffer layer formed on the organic EL layer, and a reflection electrode formed on the buffer layer. The electron injection layer is in contact with the buffer layer and is doped with an alkali metal or an alkaline earth metal. The buffer layer is formed of a conductive material that does not form an alloy with a material composing the reflection electrode. The buffer layer has a function to prevent chemical reaction between a material of the electron injection layer and a material of the reflection electrode. The material composing the buffer layer can be selected from noble metals (Au, Pt, Ag, and Pd), conductive metal oxides (RuO₂, ITO, SnO₂, IZO, TiO₂, ReO₃, V₂O₃, MoO₂, and PtO₂), and conductive metal nitrides (TiN, ZrN, and TaN). The thickness of the buffer layer is preferably in a range of 0.5 to 100 nm. The reflectivity of the reflection electrode is preferably at least 90% and the material composing the reflection electrode is preferably aluminum or silver.

In the organic EL device of the invention, a buffer layer formed of the above-described material is inserted between a reflection electrode and an electron injection layer doped with an alkali metal or an alkaline earth metal. The featured structure prevents degradation of a reflection electrode and an electron injection layer due to chemical reaction between the material of the reflection electrode and the material of the electron injection layer that occurs when these two materials are in direct contact with each other, and it achieves high electron injection efficiency. Since the movement of the material of the reflection electrode into the organic EL layer is also obstructed, the layers of the organic EL layer can retain their intrinsic performance. A buffer layer of the invention can lower the driving voltage as compared to a buffer layer of alkali metal fluoride (LiF, for example), reducing power consumption in an organic EL device.

### BRIEF DESCRIPTION OF THE DRAWINGS

The foregoing advantages and features of the invention will become apparent upon reference to the following detailed description and the accompanying drawings, of which:

The FIGURE is a sectional view of an organic EL device of an embodiment example according to the invention.

### DETAILED DESCRIPTION OF SPECIFIC EMBODIMENTS

An organic EL device according to the invention has the features described above, and the figure shows an embodiment of an organic EL device of the invention. An organic EL device of the invention comprises transparent electrode 20, organic EL layer 30, buffer layer 40, and reflection electrode 50 laminated sequentially on transparent substrate 10 in this order. Organic EL layer 30 includes hole injection layer 32, hole transport layer 34, organic light emitting layer 36, and electron injection layer 38. Although the figure shows only one light emitting part (corresponding to a pixel in the case of a monochromatic display or to a sub-pixel in the case of a multicolor display), a plurality of light emitting parts can, of course, be contained in an organic EL device.

Transparent substrate 10 must withstand the conditions, such as solvent, temperature etc., that are used in the process of forming the laminated layers and preferably exhibits good dimensional stability. Preferred materials include glass, and resins such as poly(ethylene terephthalate) and poly(methyl methacrylate). Alternatively, a flexible film formed from polyolefin, acrylic resin, polyester resin, or polyimide resin can be used for a substrate.

Transparent electrode 20 is deposited on transparent substrate 10 by means of a sputtering method. Transparent electrode 20 is formed of a conductive metal oxide such as SnO₂, In₂O₃, ITO, IZO, and ZnO:Al. Transparent electrode 20 has a transmissivity for light with wavelengths from 400 nm to 800 nm of preferably at least 50%, more preferably 85% or more.

To form an active matrix-driving type device, transparent electrode 20 consists of a plurality of electrode elements each connecting electrically to each of a plurality of switching elements formed on transparent substrate 10 in a one-to-one correspondence. To form a passive matrix-driving type device, transparent electrode 20 consists of a plurality of stripe-shaped electrode elements extending in a first direction. In the case of whole surface emission, the electrode is formed as an integral electrode.

The plural electrode elements of transparent electrode 20 can be formed by using a mask giving a desired form, or by first forming a homogeneous layer on the substrate and then applying photolithography, or applying lift off technique.

Then, organic EL layer 30 is formed on transparent electrode 20. Organic EL layer 30 includes at least organic light emitting layer 36 and electron injection layer 38 and, as required, further includes hole injection layer 32, hole transport layer 34, and an electron transport layer. Each of the layers is formed with a sufficient thickness to serve the function required by each layer. The organic EL layer can employ one of the following layer structures:
(1) organic light emitting layer/electron injection layer
(2) hole injection layer/organic light emitting layer/electron injection layer
(3) hole transport layer/organic light emitting layer/electron injection layer
(4) hole injection layer/hole transport layer/organic light emitting layer/electron injection layer
(5) hole injection layer/hole transport layer/organic light emitting layer/electron transport layer/electron injection layer.

In the above structures, an electrode functioning as an anode connects to the left side of the row of layers and an electrode functioning as a cathode connects to the right side of the row of layers. Also In the above structures, a hole injection-transport layer can be used that serves both the function of hole injection layer 32 and the function of hole transport layer 34.

Organic light emitting layer 36 can be formed of a known material. A material to obtain light emission in blue color to blue-green color, for example, can be selected from fluorescent whitening agents including benzothiazole, benzimidazole, and benzoxazole, metal chelate oxonium compounds, styrylbenzene compounds, and aromatic dimethylidine compounds. Organic light emitting layer 36 that emits light in various wavelength ranges can be formed of a material containing a host compound and an added dopant. The host compounds that can be used are distyrylarylene compound (for example IDE-120 manufactured by ldemitsu Kosan Co., Ltd.), N,N′-ditolyl-N,N′-diphenylbiphenyl amine (TPD), and aluminum tris(8-quinolinolato) (Alq₃). The dopant can be selected from perylene (blue-purple color), coumarin 6 (blue color), quinacridone compound (blue-green to green color), rubrene (yellow color), 4-dicyanomethylene-2-(p-dimethylaminostyryl)-6-methy-4H-pyran (DCM, red color), and platinum octaethyl porphyrin complex (PtOEP, red color).

A material for hole injection layer 32 can be selected from phthalocyanine (including copper phthalocyanine, CuPc) and indanthrene compounds. Hole transport layer 34 can be composed of a triarylamine such as triphenylamine derivative (TPD), N,N′-bis(1-nathtyl)-N,N′-diphenylbiphenylamine (α-NPD), 4,4′,4″-tris-(N-3-tolyl-N-phenylamino)triphenylamine (m-MTDATA), or N,N,N′-tetrabiphenyl-4,4′-biphenylenediamine (TBPB).

Electron injection layer 38 can be formed of a material consisting of a host material and a doped alkali metal or an alkaline earth metal. The host material of the electron injection layer 38 can be selected from aluminum quinolinol complex (for example, Alq₃, Almq₃, AlPrq₃, Alph₃, Alpq₃, BAlq), PBD, TPOB, and oxadiazole derivatives as shown by the following structural formulas; 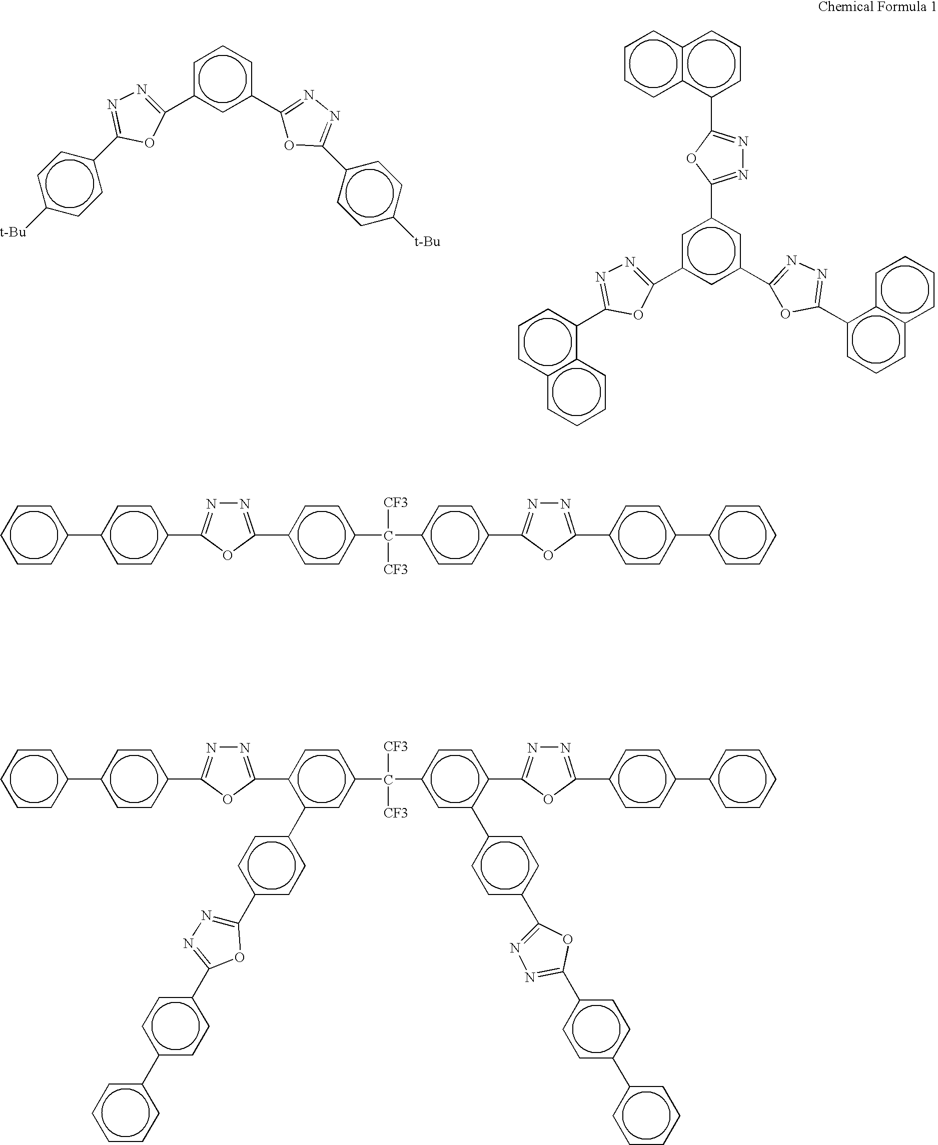 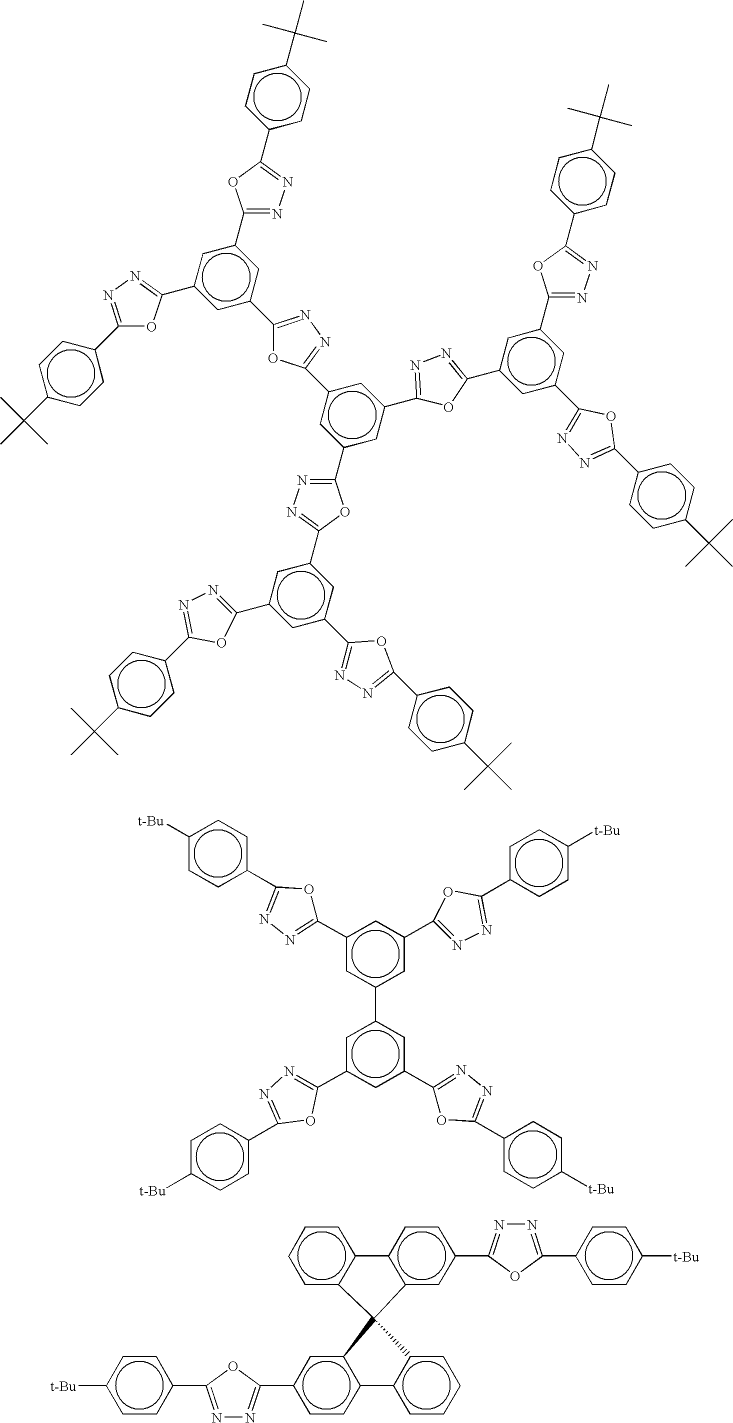
TAZ and a triazole derivative as shown by the following structural formula; 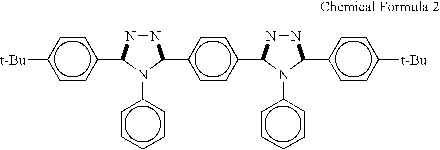
a triazine derivative as shown by the following structural formula; 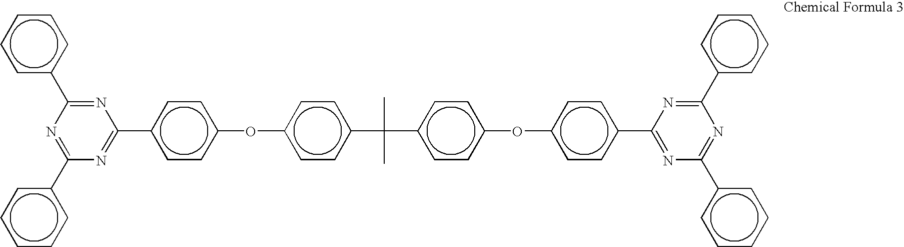
a phenyl quinoxaline as shown by the following structural formula; 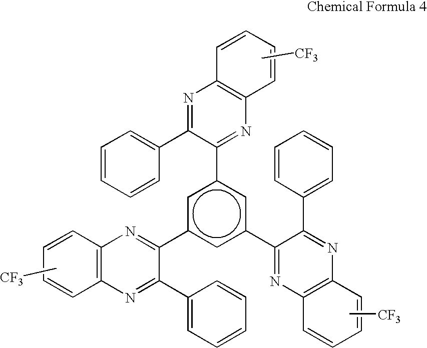
Bphen (Bathophenanthroline); ZnPBT; thiophene derivatives such as BMB-2T and BMB-3T; beryllium quinolinol complex such as Bebq₂; and silole derivatives such as PSP. (See “Organic EL materials and displays”, CMC Publishing, 2001 and “Frontiers of practical application of organic EL displays”, Toray Research Center, 2002.)

Electron injection layer 38 can be formed of the above-described host material doped with from 5 to 75 at% of an alkali metal (Li, Na, K, Rb, or Cs, for example) or an alkaline earth metal (Ca, Sr, or Ba, for example). A particularly preferred material is Alq₃ doped with an alkali metal or an alkaline earth metal. The alkali metal or the alkaline earth metal can be doped homogeneously in electron injection layer 38, or the amount of doping can gradually increase from the side of organic light emitting layer 36 to the side of reflection electrode 50.

Alternatively, electron injection layer 38 can be composed of two layers: a non-doped layer consisting of the host material alone without doping of either an alkali metal or an alkaline earth metal, and a doped layer with doping of an alkali metal or an alkaline earth metal homogeneously or with a gradient into the host material. In this structure, the non-doped layer is disposed to the side of organic light emitting layer 36 and the doped layer is disposed to the side of reflection electrode 50.

A thickness of electron injection layer 38 of the single layer type (doped homogeneously or with a gradient) is preferably in the range of 0.1 nm to 100 nm, more preferably in the range of 0.5 nm to 20 nm. In the double layer type consisting of a non-doped layer and a doped layer, a thickness of the non-doped layer is preferably in the range of 0.1 nm to 20 nm and a thickness of the doped layer is preferably in the range of 0.1 nm to 100 nm.

Each layer composing the organic EL layer can be formed by means of a technique known in the art, for example, an evaporation method (resistance heating or electron beam heating).

Buffer layer 40 prevents reflection electrode 50 and electron injection layer 38 from degradation due to chemical reaction between the material of reflection electrode 50 and the material of electron injection layer 38 that occurs when the materials of the two layers are in contact with each other. The buffer layer also inhibits movement of the material of the electrode into organic EL layer 30. A material of buffer layer 40 exhibits electrical conductivity and does not form an alloy with a material of reflection electrode 50, which exhibits high reactivity (particularly in the deposition process of the reflection electrode or in the temperature rise by driving operation). Specific materials include noble metals such as Au, Pt, Ag, and Pd, conductive metal oxides such as RuO₂, ITO, SnO₂, IZO, TiO₂, ReO₃, V₂O₃, MoO₂, and PtO₂, and conductive metal nitrides such as TiN, ZrN, and TaN. Among them, platinum is particularly favored.

A thickness of buffer layer 40 is preferably in a range of 0.5 nm to 10 nm in the case of an opaque material such as a noble metal, and in a range of 0.5 nm to 100 nm in the case of a transparent material such as ITO. Thus, a thickness of the buffer layer is preferably in a range of 0.5 to 100 nm, more preferably in a range of 0.5 to 10 nm.

Buffer layer 40 can be formed by means of a known technique in the art including an evaporation method (resistance heating or electron beam heating), a chemical vapor deposition method (CVD), an ion plating method, and a sputtering method.

Reflection electrode 50 can be deposited on buffer layer 40 by means of a technique known in the art including evaporation (resistance heating or electron beam heating), sputtering, ion plating, and laser abrasion. Reflection electrode 50 is preferably formed of a metal of aluminum or silver or an alloy of the metal that exhibits reflectivity at least 90%. Among them, aluminum is particularly favored because of its low cost and high reflectivity.

In the case of an active matrix-driving type organic EL device, transparent electrode 20 consists of a plurality of electrode elements each corresponding to a pixel (or a subpixel) and separated from each other. So, reflection electrode 50 is formed in the form of an integral electrode. On the other hand, in the case of a passive matrix-driving type organic EL device, reflection electrode 50 consists of a plurality of electrode elements with a stripe shape extending in a second direction crossing the first direction (preferably perpendicular to the first direction). In the case of whole surface emission, the reflection electrode is formed in the form of an integral electrode.

An organic EL device in this embodiment can be sealed to avoid oxidation of the electrode part due to moisture or other substance in the atmosphere. The sealing can be carried out using a sealing can of glass or a metal optionally with a desiccating agent called a getter material, or using a sealing film of a material with low moisture permeability such as metal oxide or nitride.

The present invention will be described with reference to the following specific examples. It is acknowledged that the examples do not limit the invention but various modifications are possible within the spirit and scope of the invention.

### EXAMPLE 1

Transparent electrode 20 was formed by depositing an IZO film 100 nm thick on the whole surface of glass substrate 10 by a sputtering method using a target of IDIXO (a composite oxide of indium and zinc, manufactured by Idemitsu Kosan Co, Ltd.).

The substrate having transparent electrode 20 formed thereon was installed in a resistance heating evaporation apparatus. Hole injection layer 32, hole transport layer 34, organic light emitting layer 36, electron injection layer 38, and buffer layer 40 were sequentially deposited while maintaining a vacuum. The deposition processes were conducted in a vacuum chamber at a pressure of 1×10⁻⁴ Pa. Hole injection layer 32 was formed of copper phthalocyanine (CuPc) having a thickness of 100 nm; hole transport layer 34 was formed of 4,4′-bis[N-(1-naphtyl)-N-phenylamine]biphenyl (α-NPD) having a thickness of 20 nm; organic light emitting layer 36 was formed of 4,4′-bis(2,2′-diphenylvinyl)biphenyl (DPVBi) having a thickness of 30 nm; electron injection layer 38 was formed of Alq₃ doped with 50 at % of lithium (Alq₃(Li)) having a thickness of 20 nm; and buffer layer 40 was formed of gold having a thickness of 1 nm. While maintaining the vacuum, reflection electrode 50 was formed by depositing aluminum to a thickness of 200 nm. Thus, an organic EL device having a structure of the figure was obtained.

The thus obtained organic EL device was sealed using sealing glass (not shown in the figure) and UV-hardening adhesive in a glove box under a dry nitrogen atmosphere (both the oxygen and moisture concentrations being not more than 1 ppm).

### EXAMPLE 2

An organic EL device was manufactured in the same manner as in Example 1 except that buffer layer 40 was formed of platinum.

### EXAMPLE 3

An organic EL device was manufactured in the same manner as in Example 1 except that buffer layer 40 was formed of an alloy of gold and platinum (Au:Ag=1:1).

### COMPARATIVE EXAMPLE 1

An organic EL device was manufactured in the same manner as in Example 1 except that buffer layer 40 was not formed.

### COMPARATIVE EXAMPLE 2

An organic EL device was manufactured in the same manner as in Example 1 except that buffer layer 40 was formed of LiF.

Evaluation

On the organic EL devices obtained in Examples 1 through 3 and Comparative Examples 1 and 2, the initial driving voltage at the initial brightness of 1,000 cd/m² and the driving voltage after driving operation for 2,000 hr were measured, the results of which are given in Table 1.

TABLE 1

| | initial driving voltage | driving voltage |
|---|---|---|
| | (at 1,000 cd/m²) | after driving for 2,000 hr |
| Example 1 | 8 V | 8 V |
| Example 2 | 8 V | 8 V |
| Example 3 | 8 V | 8 V |
| Comp Ex 1 | 10 V | 12 V |
| Comp Ex 2 | 9 V | 10 V |

The initial driving voltages shown in Table 1 indicate that the devices of Examples 1 through 3 exhibited lower driving voltages by 1 to 2 V as compared to the devices of Comparative Examples 1 and 2. The high driving voltage in the device of Comparative Example 1, which lacks buffer layer 40, is caused by degradation of the material composing reflection electrode 50 due to oxidation in the deposition process by the material composing electron injection layer 38 and at the same, degradation of the material composing electron injection layer 38 due to reduction by the material composing the reflection electrode 50. The high driving voltage in Comparative Example 1 is further caused by deterioration of performance of the organic EL layer due to movement of the material composing reflection electrode 50 into the organic EL layer. The device of Comparative Example 2 resulted in a driving voltage 1 volt larger than that in Examples 1 through 3. This increase in the driving voltage in Comparative Example 2 can be attributed to the insulative property of LiF used in the buffer layer. No increase of voltage was observed in the devices of Examples 1 through 3 after the driving operation at 1,000 cd/m² for 2,000 hr.

It has been demonstrated that buffer layer 40 according to the present invention prevented reflection electrode 50 and electron injection layer 38 from degradation due to chemical reaction between the material composing reflection electrode 50 and the material composing electron injection layer 38, obstructs movement of the material composing reflection electrode 50 into the organic EL layer, and reduces driving voltage of an organic EL device.

Thus, an organic EL device has been described according to the present invention. Many modifications and variations may be made to the techniques and structures described and illustrated herein without departing from the spirit and scope of the invention. Accordingly, it should be understood that the methods and apparatus described herein are illustrative only and are not limiting upon the scope of the invention.

What is claimed is:

1. An organic EL device comprising
a substrate,
a transparent electrode formed on the substrate,
an organic EL layer formed on the transparent electrode, the organic EL layer including at least an organic light emitting layer and an electron injection layer,
a buffer layer formed on the organic EL layer, and
a reflection electrode formed on the buffer layer,
wherein the electron injection layer is in contact with the buffer layer and doped with an alkali metal or an alkaline earth metal and the buffer layer is formed of a conductive material that prevents alloying with a material contained in the reflection electrode.

2. The organic EL device according to claim 1, wherein the buffer layer prevents chemical reaction between a material of the electron injection layer and a material of the reflection electrode.

3. The organic EL device according to claim 2, wherein the material contained in the buffer layer is selected from noble metals, conductive metal oxides, and conductive metal nitrides.

4. The organic EL device according to claim 3, wherein the buffer layer contains a noble metal selected from a group consisting of Au, Pt, Ag, and Pd.

5. The organic EL device according to claim 3, wherein the conductive metal oxide is selected from a group consisting of RuO₂, ITO, SnO₂, IZO, TiO₂, ReO₃, V₂O₃, MoO₂, and PtO₂.

6. The organic EL device according to claim 3, wherein the conductive metal nitride is selected from a group consisting of TiN, ZrN, and TaN.

7. The organic EL device according to claim 1, wherein a thickness of the buffer layer is in a range of 0.5 to 100 nm.

8. The organic EL device according to claim 1, wherein reflectivity of the reflection electrode is at least 90%.

9. The organic EL device according to claim 1, wherein the material contained in the reflection electrode is aluminum or silver.
